(19) United States
(12) Patent Application Publication
(10) Pub. No.: US 2015/0206674 A1
(43) Pub. Date: Jul. 23, 2015

(54) KEYBOARD AND ELECTRONIC APPARATUS

(71) Applicant: TOSHIBA TEC KABUSHIKI KAISHA, Tokyo (JP)

(72) Inventor: Osamu Watanabe, Fuji Shizuoka (JP)

(21) Appl. No.: 14/592,033

(22) Filed: Jan. 8, 2015

(30) Foreign Application Priority Data
Jan. 17, 2014 (JP) 2014-006643

(51) Int. Cl. H01H 13/86

(52) U.S. Cl. CPC H01H 13/86; H01H 2223/044; H01H 2233/002

(57) ABSTRACT

In accordance with one embodiment, a keyboard consisting of one or a plurality of keys comprises one or a plurality of key switches corresponding to the number of the keys, a cover sheet and a protection piece. The key switch includes a main body and a key top which protrudes from the main body, and is pressed into the main body for a predetermined stroke when a pressing operation is carried out and is returned to the original position when the pressing operation is released. The cover sheet covers the key switch. The protection piece is fixed on the cover sheet at a position between the key top and the cover sheet.

### CROSS-REFERENCE TO RELATED APPLICATION

This application is based upon and claims the benefit of priority from Japanese Patent Application No. 2014-006643, filed Jan. 17, 2014, the entire contents of which are incorporated herein by reference.

### FIELD

Embodiments described herein relate generally to a keyboard and an electronic apparatus.

### BACKGROUND

Conventionally, there is a keyboard in which the key switch is covered by a cover sheet. The cover sheet is arranged in a keyboard which is desired to be capable of coping with the moisture and dust, such as a keyboard of an apparatus located at a place where there is moisture or dust.

The cover sheet is made of a material that can be bent softly. The material has some elasticity. The cover sheet is flat in a case in which the stroke of the key top is small, and is formed to have concave-convex shape for each key switch in a case in which the stroke of the key top is large.

Incidentally, the key top is, for example, 7 mm thick and is smaller than the fingertip in most cases. Further, the key top is harder than the finger. For these reasons, the cover sheet dents together with the key top in the finger when the key top is pressed by a finger. Such an operation is carried out repeatedly on the keyboard, thus, the cover sheet is rubbed against the key top, as a result, damage is caused to the cover sheet gradually, and the cover sheet may be broken along the edge of the key top. Further, in a case in which display, such as characters or images indicating the function assigned to each key is printed at the inner side of the cover sheet facing the key top, the display may be scrapped and faded due to the operation mentioned above.

### BRIEF DESCRIPTION OF THE DRAWINGS

FIG. 1 is a perspective view illustrating the appearance of a weighing device according to one embodiment;

FIG. 2 is a block diagram illustrating the electrical connection between each section of the weighing device according to the embodiment;

FIG. 3 is a perspective view illustrating the appearance of the inner side of a cover sheet of an operation display section according to the embodiment;

FIG. 4 is a perspective view illustrating the appearance of a protection sheet adhered to the inner side of the cover sheet according to the embodiment;

FIG. 5 is a perspective view illustrating the appearance of the protection piece of the protection sheet according to the embodiment;

FIG. 6 is a cross-sectional view illustrating the structure of a keyboard according to the embodiment;

FIG. 7 is a cross-sectional view illustrating a protection sheet and a cover sheet according to a modification of the embodiment;

FIG. 8 is a perspective view illustrating the protection sheet according to the modification of the embodiment; and

FIG. 9 is a cross-sectional view illustrating the protection sheet according to the modification of the embodiment.

### DETAILED DESCRIPTION

In accordance with one embodiment, a keyboard consisting of one or a plurality of keys comprises one or a plurality of key switches corresponding to the number of the keys, a cover sheet and a protection piece. The key switch includes a main body and a key top which protrudes from the main body, and is pressed into the main body for a predetermined stroke when a pressing operation is carried out and is returned to the original position when the pressing operation is released. The cover sheet covers the key switch. The protection piece is fixed on the cover sheet at a position between the key top and the cover sheet.

In accordance with one embodiment, an electronic apparatus comprises a keyboard as stated above and a control section configured to carry out a processing when receiving a signal generated along with a key input on the keyboard.

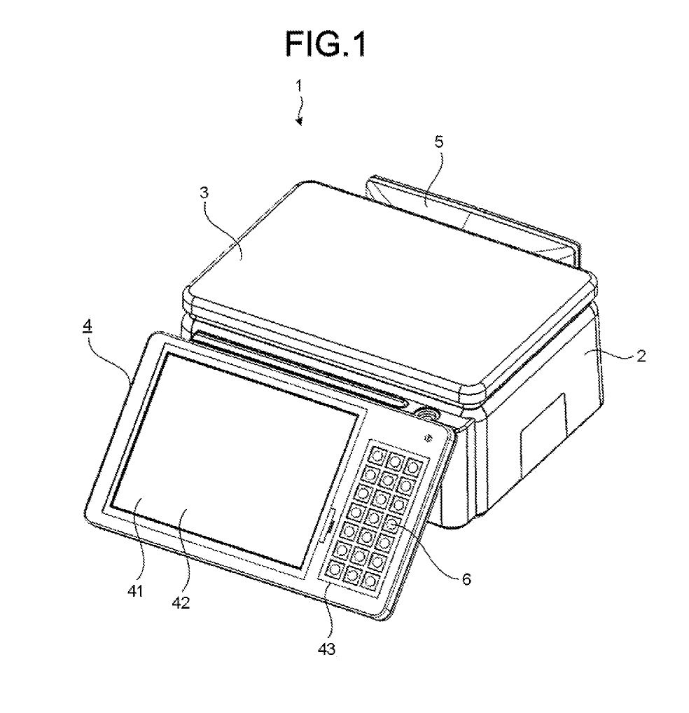

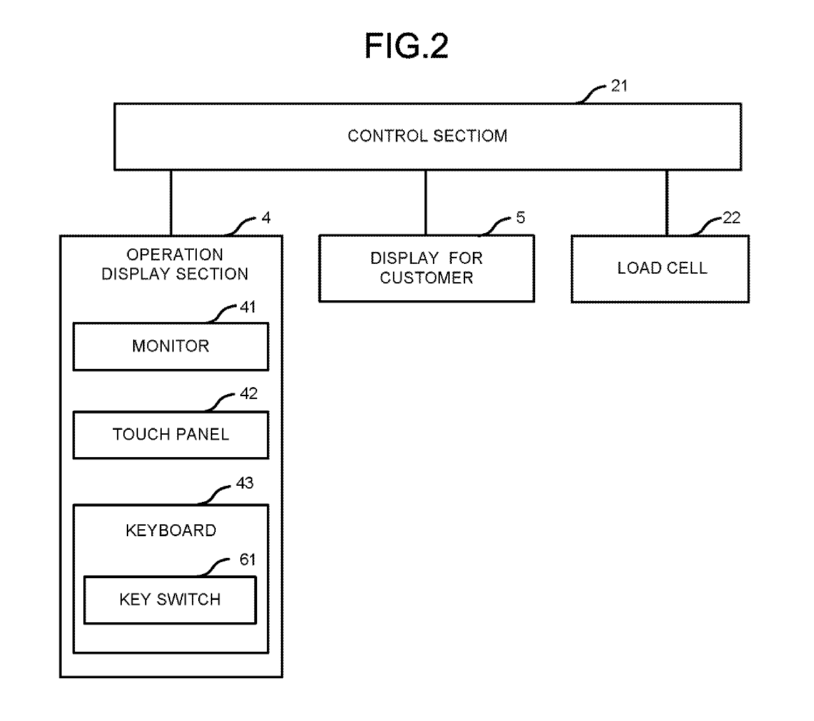

The embodiment is described with reference to the accompanying drawings. FIG. 1 is a perspective view illustrating the appearance of a weighing device 1. FIG. 2 is a block diagram illustrating the electrical connection between each section of the weighing device 1. The weighing device 1 includes a main body 2, an upper tray 3, an operation display section 4 and a display for customer 5.

The main body 2 is equipped with a built-in control section 21 and a load cell 22. The control section 21 includes a CPU (Central Processing Unit), a ROM (Read Only Memory), a RAM (Random Access Memory) (none is shown) and the like. The ROM stores various data and various programs executed by the CPU. The RAM temporarily stores the data and programs when the CPU executes various programs. The CPU develops and executes the program read from the ROM on the RAM to collectively control each section of the weighing device 1.

The load cell 22 sends the output corresponding to the weight of a weighing target placed on the upper tray 3 to the control section 21. The control section 21 calculates the weight of the weighing target according to the output from the load cell 22.

The operation display section 4 receives an operation by an operator and displays an image indicating various kinds of information to the operator. The display for customer 5 displays an image indicating various kinds of information to a customer.

The operation display section 4 includes a monitor 41, a touch panel 42, and a keyboard 43. The monitor 41 displays an image. The touch panel 42, laminated on the surface of the monitor 41, outputs the coordinate of a touched position to receive an operation corresponding to the image displayed on the monitor 41.

The keyboard 43 consists of, for example, a plurality of keys 6 arranged in a matrix state. The keys 6 output a signal according to a key input. The control section 21 carries out a processing after it receives the signal.

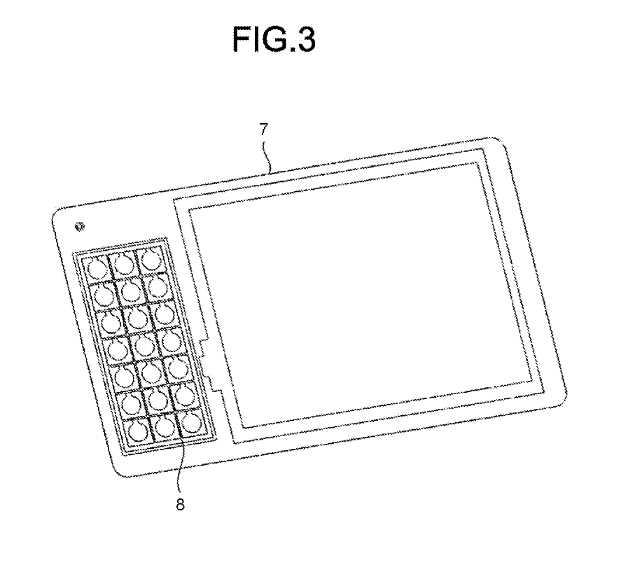

The keyboard 43 has a cover sheet 7. FIG. 3 is a perspective view illustrating the appearance of the inner side of the cover sheet 7. The cover sheet 7 in the present embodiment has a size covering the whole operation display section 4 except the touch panel 42. The thickness of the cover sheet 7 is, for example, 0.1 mm. The cover sheet 7 covers the monitor 41, the touch panel 42 and the keyboard 43 to protect these sections from moisture and dust. Further, characters or images indicating the function assigned to each key 6 are printed at the inner side of the cover sheet 7.

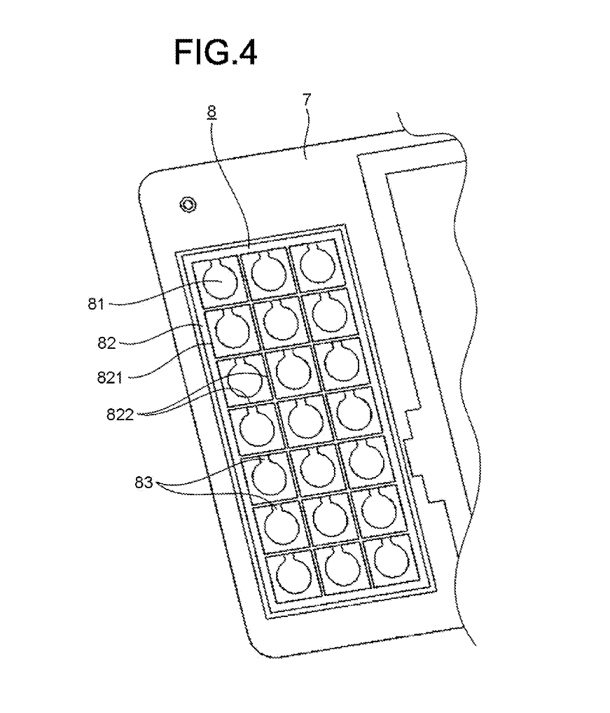

The keyboard 43 further includes a protection sheet 8. FIG. 4 is a perspective view illustrating the appearance of the protection sheet 8. The protection sheet 8 is adhered to the inner side of the cover sheet 7 by a double-sided tape (not shown) and the like. The protection sheet 8 integrates a plurality of protection pieces 81 into a frame 82 through connection parts 83. The protection sheet 8 can be created by, for example, punching a sheet-like material. The thickness of the protection sheet 8 is, for example, 0.2 mm. The thickness of the double-sided tape is, for example, 0.15 mm.

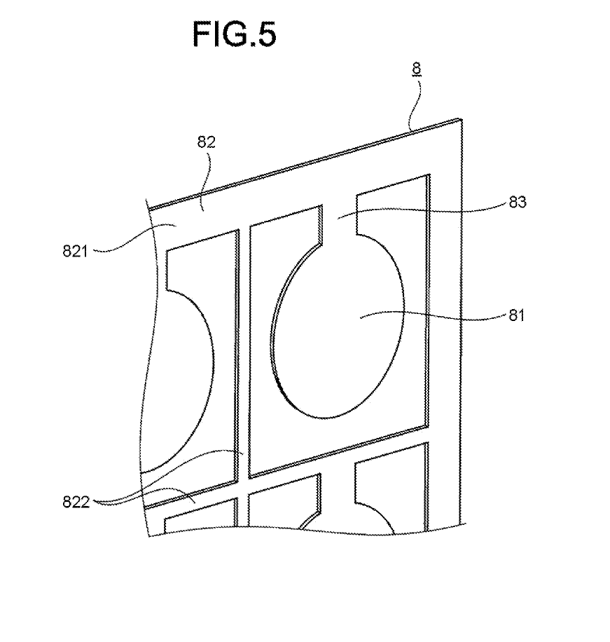

The relation between the protection piece 81, the frame 82 and the connection part 83 is described in detail. FIG. 5 is a perspective view illustrating the appearance of the protection piece 81 of the protection sheet 8. The frame 82, which is in a grid shape corresponding to the matrix arrangement of the keys 6, includes an outer periphery 821 surrounding the keyboard 43 and partition portions 822 passing between the keys 6. One end of the connection part 83 in narrow strip shape is connected with upper end of the protection piece 81, and the other end is connected with the outer periphery 821 or the partition portion 822. That is, the connection part 83 connects the protection piece 81 with the outer periphery 821 or the partition portion 822. In this way, the protection pieces 81 are positioned in individual frames separated by the outer periphery 821 and the partition portion 822 of the frame 82. With such a constitution, all the protection pieces 81 are arranged integrally.

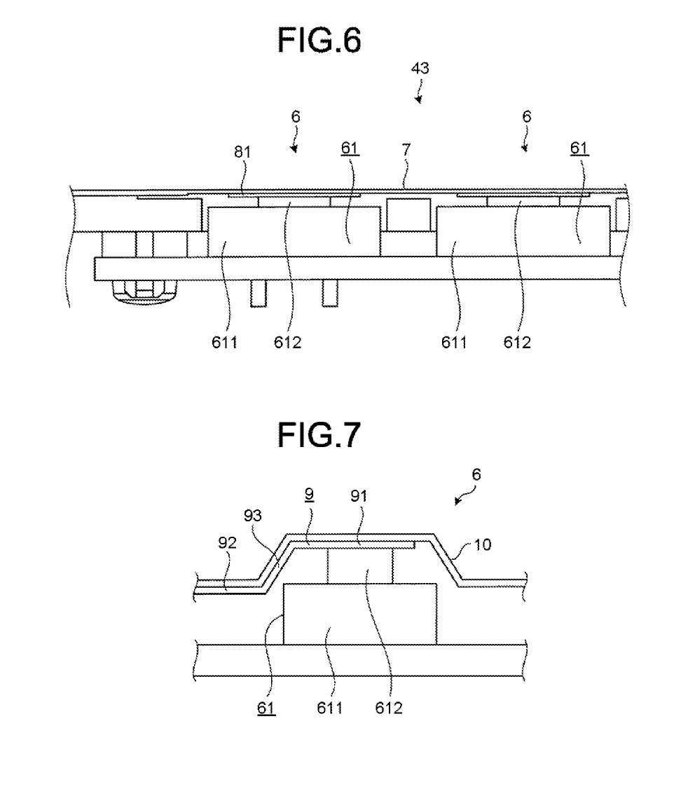

The protection pieces 81 serve as the components of the keys 6. FIG. 6 is a cross-sectional view illustrating the structure of the keyboard 43. Each key 6 consists of a key switch 61 and the protection piece 81.

The key switch 61 includes a main body portion 611 and a key top 612. The shape of the key top 612 is, for example, a round shape having a diameter of about 7 mm. The protection piece 81, in, for example, a round shape having a diameter of about 11 mm, is arranged in such a manner that the key top 612 is at the approximate center thereof. In this way, the outer periphery of the protection piece 81 extends to a position about 2 mm away from the outer periphery of the key top 612.

It goes without saying that the size of the protection piece 81 is not limited to that described above, and no specific limitation is given to the size of the protection piece 81 as long as the protection piece 81 can be fitted into the area of each key 6 and touched by a fingertip, and is larger than the key top 612.

With such a constitution, when the key 6 is operated, that is, pressed, the key top 612 is pressed by a predetermined stroke. At this time, the cover sheet 7 extends along with the pressing operation. When the key top 612 is pressed, the key switch 61 outputs a signal. The control section 21 carries out a processing after receiving a signal that is output along with the key input.

In accordance with the present embodiment, each key 6 includes the protection piece 81, in this way, the cover sheet 7 having a thickness of, for example, 0.1 mm is reinforced to a thickness of 0.45 mm, including the double-sided tape. In this way, the cover sheet 7 is less likely to dent together with the key top 612 in the finger during the operation of the keys 6.

Thus, the damage of the cover sheet 7 along the edge of the key top 612 caused by the repeating of the operation is less likely to occur. Further, it is possible to prevent that the display arranged at the surface of the cover sheet 7 at the side of the key top 612 is scrapped and faded.

Further, the key switch 61 is operated across the protection piece 81 having a diameter larger than that of the key top 612, thus, the key top 612 is pressed more easily compared with a case in which the key top 612 much smaller than the fingertip is pressed across the soft cover sheet 7 only. That is, the operability can be improved if each key 6 is equipped with the protection piece 81.

In the present embodiment, it is assumed that the stroke of the key top 612 is not large, that is, the subduction amount of the protection piece 81 is not large, and a flat cover sheet 7 is used. The cover sheet 7 made of a material that can be bent softly has elasticity. The part of the cover sheet 7 where no protection piece 81 is attached, that is, the part between the protection pieces 81 is retractable. Thus, the adjacent protection pieces 81 are flexible, and the operability of the keys 6 is not impaired.

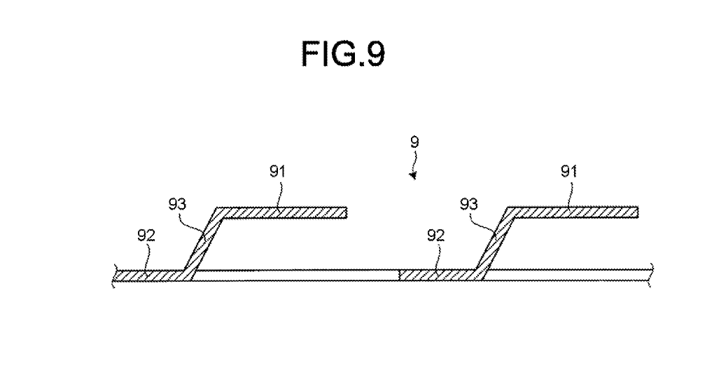

On the contrary, in a case in which the stroke of the key top 612 is large, a cover sheet having a concave-convex shape for each key switch 61 is adopted to guarantee the operability of the keys 6. This case is described with reference to FIG. 7˜FIG. 9 as the modification of the embodiment.

Hereinafter, the modification of the present embodiment is described. In the modification, the same parts as those described in the embodiment are not described repeatedly.

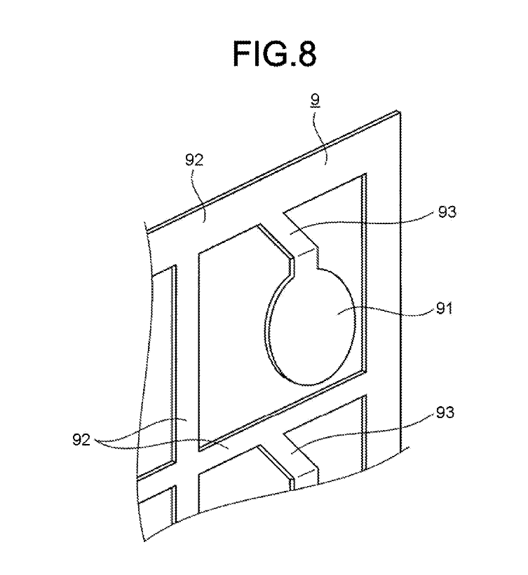

FIG. 7 is a cross-sectional view illustrating a protection sheet 9 and a cover sheet 10 according to the modification. FIG. 8 is a perspective view illustrating the protection sheet 9 according to the modification. FIG. 9 is a cross-sectional view illustrating the protection sheet 9 according to the modification.

The concave-convex shape for each key switch 61 is arranged in a matrix state in the cover sheet 10.

The protection sheet 9 includes protection pieces 91, a frame 92 and connection parts 93, and the connection parts 93 are embossed along the inner surface shape of the key switch 61 so as to lift up the protection piece 91 with respect to the frame 92.

With such a constitution, it is possible to cope with the large stroke through the deflection of the cover sheet 10 and the connection part 93, even in a case of a keyboard which is not capable of coping with the large stroke of the key top through the elasticity of the flat cover sheet only.

In accordance with the embodiment and the modification described above, the cover sheet is protected from the key top through the protection piece, in this way, it is possible to prevent the damage of the cover sheet such as the breakage, the scraping of the display and the like.

In addition, the shape of the protection piece in the embodiment described above is a round shape; however, it is not limited to this according to different applications. The protection piece may be of any shape (for example, rounded shape) as long as it has no angle that causes damage to the cover sheet.

In the embodiment described above, the protection pieces are connected with the frame through connection parts to constitute the protection sheet; however, for example, the protection pieces may be collectively connected with each other according to different applications. In this case, it is desired that the intervals between the protection pieces are stretchable.

Further, in the embodiment described above, the protection pieces are adhered to the inner side of the cover sheet; however, the protection pieces may be fixed on the cover sheet through other methods than the adhering method; alternatively, the protection pieces may be fixedly integrated with the cover sheet.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A keyboard consisting of one or a plurality of keys, comprising:
one or a plurality of key switches corresponding to the number of the keys configured to include a main body and a key top which protrudes from the main body, and is pressed into the main body for a predetermined stroke when a pressing operation is carried out and is returned to the original position when the pressing operation is released;
a cover sheet configured to cover the key switch; and
a protection piece configured to be fixed on the cover sheet at a position between the key top and the cover sheet.

2. The keyboard according to claim 1, wherein
the number of the keys is more than one,
the protection pieces are arranged for each of the key switches, and
all the protection pieces are arranged integrally.

3. The keyboard according to claim 2, wherein
the plurality of protection pieces is respectively connected in framework of a grid-like frame formed by punching a sheet-like material.

4. The keyboard according to claim 1, wherein
the protection piece is of a size that can be fitted into the area of each key and is larger than the key top.

5. An electronic apparatus comprising:
a keyboard according to claim 1; and
a control section configured to carryout a processing when receiving a signal generated along with a key input on the keyboard.
